(19) United States
(12) Patent Application Publication
(10) Pub. No.: US 2007/0162768 A1
(43) Pub. Date: Jul. 12, 2007

(54) Electronic circuit

(75) Inventors: Adrianus Josephus Bink, Eindhoven (NL); Mark Nadim Olivier De Clercq, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,584

(22) PCT Filed: Feb. 24, 2005
(86) PCT No.: PCT/IB05/50685

§ 371 Date: Sep. 5, 2006

(30) Foreign Application Priority Data
Mar. 10, 2004 (EP) 04100982.0

(51) Int. Cl. G06F 9/44; G06F 15/00; G06F 7/38; G06F 9/00

(52) U.S. Cl. 713/194; 712/225; 280/28

(57) ABSTRACT

There is provided an electronic circuit that is harder to crack using power analysis techniques, the electronic circuit comprising first and second pipeline stages and a latch positioned between the pipeline stages; wherein the electronic circuit is adapted to operate in a normal mode in which the latch is opened and closed in response to an enable signal, and a reduced mode in which the latch is held open to reduce a current peak associated with the opening and closing of the latch.

### TECHNICAL FIELD OF THE INVENTION

The present invention relates to the field of electronic circuits, and in particular to the integration of a cryptography feature in an electronic circuit comprising a pipeline.

### BACKGROUND OF THE INVENTION

Microprocessors are often used for applications involving cryptography. One example of this is microprocessors used in smart cards. For these applications, the security of the data is of prime importance and much effort is expended in ensuring that microprocessors are difficult to decipher or crack.

One of the most common ways of deciphering a microprocessor is by monitoring the power output of the smart card. The most basic form of this technique is referred to as simple power analysis (SPA), and a more complex technique is termed differential power analysis (DPA).

In pipelined processors, the clocking of each stage of the microprocessor produces current peaks that can be monitored and used in SPA and DPA. These current peaks can then be analysed to extract the data being processed by the smart card.

One way to reduce the effectiveness of power output analysis techniques such as SPA and DPA is to randomise and minimise the occurrence of current peaks.

In synchronous systems, at every rising edge of the clock signal, new data is latched into all flip-flops of each stage. The simultaneous clocking of all the stages of the pipeline of the microprocessor results in a large current peak, which is easily detectable using DPA and SPA. Techniques such as voltage scaling or that disclosed in “Secure Contactless Smartcard ASIC with DPA Protection” IEEE Journal of Solid State Circuits, Vol. 36, No. 3, March 2001, p 559-565 by Patrick Rakers, Larry Connell, Tim Collins and Dan Russell have been developed for reducing these current peaks and making the synchronous microprocessor-based smartcards more secure. However, these techniques require the addition of an isolation network or voltage scaling circuit, which increases the amount of hardware required.

Alternatively, asynchronous microprocessors can be used instead of synchronous ones.

Many asynchronous microprocessors use ‘pipelines’ to increase parallelism and performance. That is, where instruction execution in a microprocessor comprises several independent steps, separate units can be created in the microprocessor to carry out each step. When a unit finishes executing an instruction, it is passed on to the next unit in the ‘pipeline’, and starts work on the next instruction. Therefore, although the length of time required for an entire instruction to be executed remains the same as in a non-pipelined system, as the next instruction is only one unit behind, the overall result is that the performance of the microprocessor is improved.

Unlike synchronous circuits in which a global clock signal controls how long a component processes data and when that data propagates to the next part of the system, components in asynchronous systems execute tasks at their own rate, and only move on to the next task when the next part of the system has acknowledged receipt of the data.

Therefore, as asynchronous microprocessors do not have a global clock to latch the data through the pipeline stages, and data is only latched when and where needed, current peaks are reduced in size and are spread out in time when compared to a synchronous microprocessor. Therefore, it is much more difficult to interpret what instructions and data are being processed by the microprocessor using the SPA and DPA techniques.

However, current peaks do still exist and, although being more difficult to identify, they can still lead to the microprocessor data being fraudulently interrogated.

There is therefore a need for a technique to further randomise the occurrence and magnitude of current peaks in asynchronous processors.

### SUMMARY OF THE INVENTION

According to a first aspect of the present invention, there is provided an electronic circuit comprising first and second pipeline stages; and a latch positioned between the pipeline stages; wherein the electronic circuit is adapted to operate in a normal mode in which the latch is opened and closed in response to an enable signal, and a reduced mode in which the latch is held open to reduce a current peak associated with the opening and closing of the latch.

Preferably, the electronic circuit comprises a third pipeline stage and a second latch, the second latch positioned between the second and third pipeline stages.

When the electronic circuit is operating in the reduced mode, both of the first and second latches can be held open to reduce the current peaks associated with the opening and closing of the latches.

Alternatively, when the electronic circuit is operating in the reduced mode, one of the first and second latches is held open to reduce the current peak associated with the opening and closing of that latch. Preferably, the latch held open changes over time. Preferably, the first and second latches are held open for different lengths of time.

Preferably, the length of time that the electronic circuit operates in the reduced mode varies.

According to another aspect of the present invention, there is provided a method of operating an electronic circuit, the electronic circuit comprising first and second pipeline stages and a latch positioned between the stages, the method comprising operating the electronic circuit in a normal mode in which the latch is opened and closed in response to an enable signal, and a reduced mode in which the latch is held open to reduce a current peak associated with the opening and closing of the latch.

### BRIEF DESCRIPTION OF THE DRAWINGS

For a better understanding of the present invention, and to show more clearly how it may be carried into effect, reference will now be made, by way of example, to the following drawings, in which:

FIG. 1 is a five-stage pipeline in accordance with one aspect of the present invention;

FIG. 2 shows one implementation of a pipeline latch controller in accordance with an embodiment of the present invention; and

FIG. 3 shows control signals according to the invention.

### DETAILED DESCRIPTION OF THE PREFERRED EMBODIMENTS

Although the present invention will be described below with reference to a pipeline in an asynchronous microprocessor, it will be appreciated that the present invention is applicable to any type of electronic circuit having a pipeline.

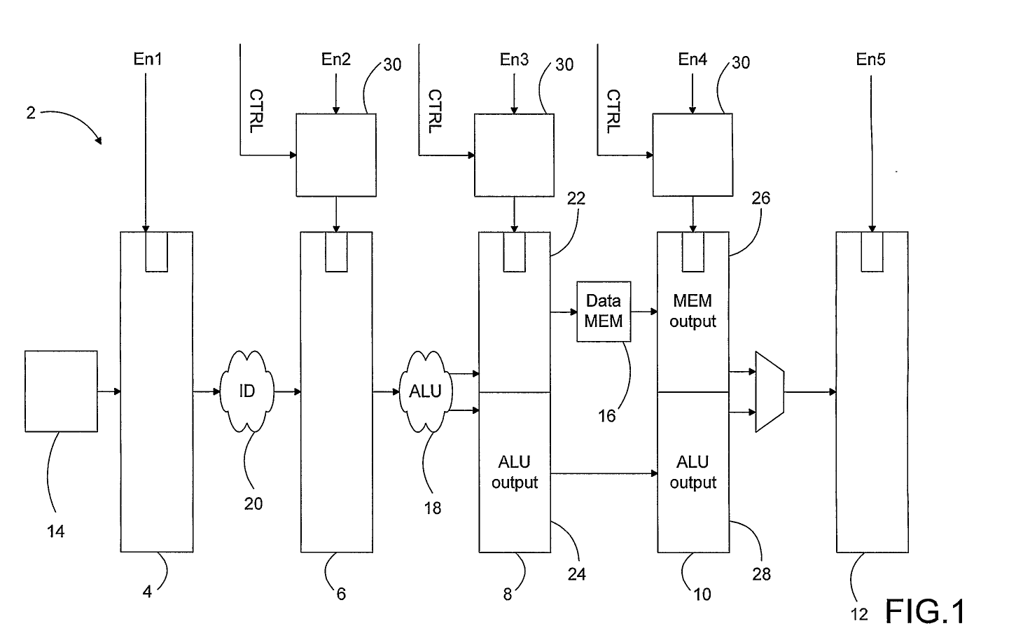

FIG. 1 shows a five-stage pipeline in accordance with an aspect of the present invention. Although the invention will be described with reference to a five-stage pipeline, it will be appreciated that the invention is applicable to pipelines having any number of stages.

The stages of the pipeline 2 each comprise a respective latch (4, 6, 8, 10 and 12), and as conventional, each latch has a respective enable signal, En1, En2, En3, En4 or En5, which determines the operating mode of the latch. When the latch is enabled, the output of the latch is the same as the input of the latch, and the latch is called transparent. When the latch is disabled, the output of the latch holds the last value at its input.

An instruction memory 14 is connected to the first latch 4, and this stores the instructions for the processor pipeline 2. The instructions may comprise load instructions, which are used to access a particular address in a data memory 16, or may comprise arithmetic computation instructions that are to be executed by an arithmetic and logic unit (ALU) 18. Other types of instructions, for example, are Compare instructions, Jump instructions, Branch instructions and Store instructions.

The retrieved instruction is stored in the first latch 4, and is passed to a first unit 20. The first unit 20 is commonly known as the decode stage and decodes the retrieved instruction. The output of the first unit 20, which may comprise control and data signals, is stored in the second latch 6, when the second latch 6 has received confirmation that the preceding instruction has been safely stored in the third latch 8. These control and data signals tell each stage of the pipeline which operation they should perform.

The instruction stored in the second latch 6 is then executed by ALU 18. If the instruction is an arithmetic computation instruction, the ALU 18 performs the computation. However, if the instruction is a load instruction, the ALU 18 calculates the address that must be accessed in the data memory 16 at the fourth stage of the pipeline 2. The result of the computation is then stored in a register 22 or 24 of the third latch 8 when the third latch 8 has received confirmation that the preceding instruction has been stored by the next stage. The particular register 22, 24 within the third latch 8 that stores the result is determined by the nature of the instruction being processed. For example, if the instruction is a load instruction, the result is stored in the top register 22 so that the data memory 16 can be accessed. Alternatively, if the instruction is an arithmetic instruction, the result is stored in the bottom register 24. In one implementation, the enable signal En3 in conjunction with conditional bits allows the selection of the separate registers 22, 24.

In the fourth stage, if the present instruction is a load instruction, the data memory 16 is accessed and the required data read out to the top register 26 of latch 10. If the present instruction is an arithmetic computation instruction, the result from the third stage (stored in latch 8) is now stored in the bottom register 28 of latch 10.

Although only two registers are shown in each of the third and fourth latches 8 and 10, it will be appreciated that there may be more than two, and the exact number will depend on the types of instructions that the pipeline can process.

In the fifth stage, the result of the fourth stage (stored in latch 10) is written into latch 12 (hereinafter referred to as the ‘register file’).

As described above, this asynchronous pipeline does not have, by definition, a global clock signal for controlling the latching of data through the pipeline stages and hence current peaks are reduced in size and are spread out in time when compared to a synchronous microprocessor. However, current peaks do still exist and, although harder to identify, they can still lead to the data in the asynchronous microprocessor being cracked.

Therefore, in accordance with the invention, one or more of the latches in the microprocessor pipeline are controllable so that they can be randomly held in a transparent mode, effectively combining the two adjacent stages of the pipeline into one stage, and reducing the current peaks associated with the latching of data through the pipeline. By varying the latch in the pipeline that is held transparent, the timing of current peaks can also be randomised.

Therefore, in the aspect of the invention illustrated in FIG. 1, latch control circuits 30 are provided to control the operation of the second, third and fourth stage latches 6, 8 and 10. Each latch control circuit 30 receives the appropriate latch enable signal and a control signal (CTRL).

According to alternative aspects of the present invention, the latch controller or further latch controllers can be connected to other latches in the pipeline, and not just the second, third and fourth latches as shown in FIG. 1.

The latch control circuit 30 acts to control the mode of operation of the associated latch. If the control signal (CTRL) indicates that the latch should be operated normally, the latch control circuit 30 causes the latch to be operated by the enable signal, En. That is, the enable signal controls whether the latch is transparent (i.e. when it is loading the next data to be stored) or whether it is holding the last value at its input when the latch was last enabled.

However, when it is desired to reduce the current peak associated with the opening and closing of the latch, the control signal (CTRL) causes the latch to become transparent, effectively combining two adjacent stages into one stage. That is, the latch control circuit 30 overrides the enable signal En, and holds the latch in a transparent state. Once data is input into the first of these two stages, the latch is held in a transparent mode until the next non-transparent latch acknowledges receipt of the result of the instruction (the length of time required for this acknowledgement will depend on the handshaking protocol being used in the system).

It will be appreciated that one or more latches (whether or not those latches are in consecutive positions within the pipeline) may be held in a transparent state at a time.

A pipeline 2, having a mode in which one or more of the latches are held open, effectively rendering that stage transparent, is known as a reduced pipeline.

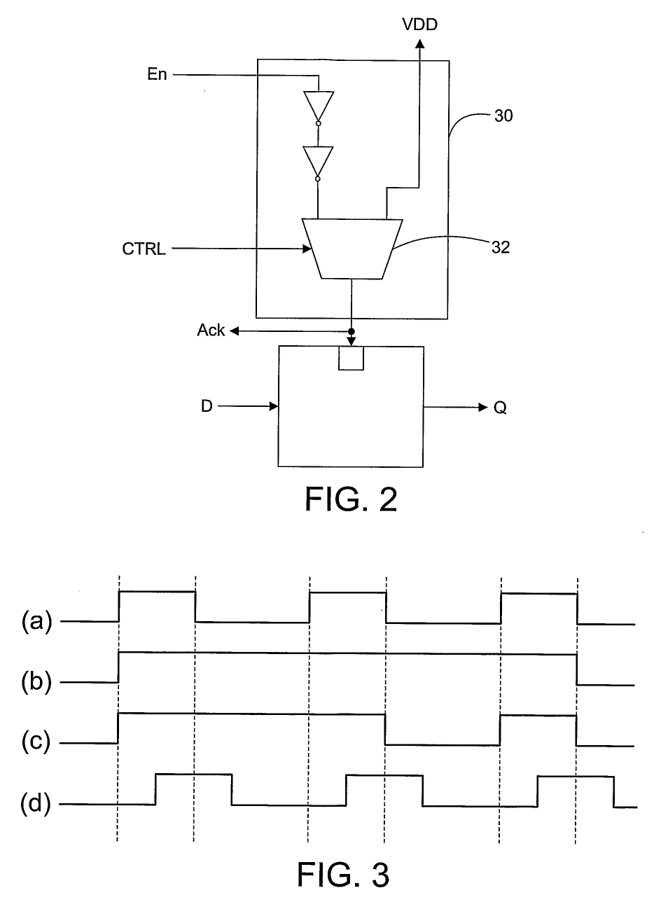

One implementation of a pipeline latch controller is shown in FIG. 2. The latch is switched between a normal latching mode (in which it is controlled by an enable signal En) and a reduced mode where it is kept transparent.

In this Figure, a high value of the enabling signal (En) is translated into the latch becoming transparent. However, the adaptation of this controller to the opposite situation, in which a low value of the enabling signal (En) makes the latch transparent, will be readily apparent to a person skilled in the art.

In the latch controller 30, the switching between the reduced mode and a normal mode is determined by the control signal (CTRL). The control signal (CTRL) controls the operation of a multiplexer 32, which has an enable signal (En) and a supply voltage signal (VDD) as its inputs.

If it is determined that the latch should be reduced to randomise the occurrence and magnitude of current peaks, the multiplexer 32 is controlled by the control signal (CTRL) so that the supply voltage signal (VDD) controls the operation of the latch. Therefore, the latch will be forced into a transparent state, regardless of the value of the enable signal (En). When the latch is to be used by the pipeline again, the control signal operates the multiplexer 32 so that the enable signal (En) is passed to the latch, allowing data to be stored in the latch as normal.

It will be appreciated that the latch control circuit described above and shown in FIG. 2 is exemplary and is merely one of many possible latch control circuits that may be used to implement the present invention. Many alternative types of latch control circuit will be readily apparent to a person skilled in the art.

Therefore, a latch with such a controller can be switched into a transparent mode whilst the other latches in the system can keep latching normally in response to their enable signals. If there are multiple latch controllers in the pipeline, each latch controller may receive the same control signal, or may receive individual control signals.

The control signal (CTRL) is generated by a random signal generator (not shown). The signal generator is configured to operate such that the “random” signal is safe with regard to the latch operation. For example, if a latch that is currently storing data is switched into a transparent state before the next latch stores that data, the data will be lost. FIG. 3 illustrates two exemplary safe control signals.

Signal (a) is an enable signal for a conventional latch. The rising edge corresponds to the point where the latch is put into a transparent (or open) mode to load the next data, and the falling edge corresponds to the point where the latch is closed and the data stored.

Signals (b) and (c) show first and second safe control signals in accordance with the invention. As the rising and falling edges of the signals correspond to those of the original enable signal, the introduction of setup and hold violations in the registers are prevented, and the signals are considered safe.

Signal (d) shows a signal that is unsafe, as the rising and falling edges do not correspond to those in the original enable signal.

Therefore, as asynchronous microprocessors have reduced current peaks compared to their synchronous equivalents, pipeline reduction can be used to randomly open the latch of a certain stage in the pipeline, resulting in a random occurrence of those smaller current peaks. This means that it is more difficult to determine what action has just occurred in the microprocessor, and therefore it is more difficult to fraudulently interrogate the data of the smart card.

A second advantage results from the fact that, in the cases where a pipeline stage is reduced, there is no need to activate the latches of that stage, thus decreasing the power consumption of the chip.

A third advantage stems from the fact that it is possible to program the situations in which the latches are to be transparent. Thus, the microprocessor could run normally (i.e. with all latches in a normal mode) when high performance is needed, but use pipeline reduction when processing sensitive data.

It should be noted that the above-mentioned embodiments illustrate rather than limit the invention, and that those skilled in the art will be able to design many alternative embodiments without departing from the scope of the appended claims. The word ‘comprising’ does not exclude the presence of elements or steps other than those listed in a claim.

1. An electronic circuit comprising:
first and second pipeline stages; and
a latch positioned between the pipeline stages;
wherein the electronic circuit is adapted to operate in a normal mode in which the latch is opened and closed in response to an enable signal, and a reduced mode in which the latch is held open to reduce a current peak associated with the opening and closing of the latch.

2. An electronic circuit as claimed in claim 1, further comprising a latch control circuit connected to the latch, the latch control circuit being adapted to control the latch with the enable signal when the electronic circuit is in the normal mode, and to hold the latch open when the electronic circuit is in the reduced mode.

3. An electronic circuit as claimed in claim 1, the electronic circuit further comprising a third pipeline stage and a second latch, the second latch positioned between the second and third pipeline stages.

4. An electronic circuit as claimed in claim 3, wherein, when the electronic circuit is operating in the reduced mode, both of the first and second latches are held open to reduce the current peaks associated with the opening and closing of the latches.

5. An electronic circuit as claimed in claim 3, wherein, when the electronic circuit is operating in the reduced mode, one of the first and second latches is held open to reduce the current peak associated with the opening and closing of that latch.

6. An electronic circuit as claimed in claim 5, wherein the latch held open changes over time.

7. An electronic circuit as claimed in claim 6, wherein the first and second latches are held open for different lengths of time.

8. An electronic circuit as claimed in claim 1, wherein the length of time that the electronic circuit operates in the reduced mode varies.

9. An electronic circuit as claimed in claim 3, further comprising a second latch control circuit connected to the second latch.

10. An electronic circuit as claimed in claim 9, wherein the latch control circuits receive a signal indicating the mode of operation of the electronic circuit.

11. An electronic circuit as claimed in claim 10, wherein the signal indicates whether the first latch, second latch or both latches are to be held open when the electronic circuit is operating in the reduced mode.

12. An electronic circuit as claimed in claim 9, wherein each latch control circuit receives a respective control signal, indicating whether its respective latch is to be held open when the electronic circuit is operating in the reduced mode.

13. A method of operating an electronic circuit, the electronic circuit comprising first and second pipeline stages and a latch positioned between the stages, the method comprising:
operating the electronic circuit in a normal mode in which the latch is opened and closed in response to an enable signal, and a reduced mode in which the latch is held open to reduce a current peak associated with the opening and closing of the latch.

14. A method as claimed in claim 13, the electronic circuit further comprising a third pipeline stage and a second latch, the second latch positioned between the second and third pipeline stages; the method further comprising:
holding the second latch open when the electronic circuit is operating in the reduced mode to reduce a current peak associated with the opening and closing of the second latch.

15. A method as claimed in claim 14, wherein the first latch and second latch are held open at different times when the electronic circuit is operating in the reduced mode.

16. A method as claimed in claim 15 wherein the first latch and second latch are held open for different lengths of time.

17. A method as claimed in claim 14, wherein, when the electronic circuit is operating in the reduced mode, both the first latch and second latch are held open.

18. A method as claimed in claim 13 wherein the length of time that the electronic circuit operates in the reduced mode varies.
